(19) United States
(12) Patent Application Publication
(10) Pub. No.: US 2010/0316321 A1
(43) Pub. Date: Dec. 16, 2010

(54) TAPERED ROLLER BEARING

(76) Inventors: Eiichi Nakamizo, Mie (JP); Hideshi Nishiwaki, Mie (JP); Tsukasa Toyoda, Mie (JP)

Correspondence Address: WENDEROTH, LIND & PONACK, L.L.P., 1030 15th Street, N.W.,, Suite 400 East, Washington, DC, 20005-1503, US

(21) Appl. No.: 12/521,329

(22) PCT Filed: Nov. 30, 2007
(86) PCT No.: PCT/JP2007/073193

§ 371 Date: Jun. 26, 2009

(30) Foreign Application Priority Data
Dec. 28, 2006 (JP) 2006-354872
Nov. 29, 2007 (JP) 2007-309138

(51) Int. Cl. F16C 33/58

(52) U.S. Cl. 384/571

(57) ABSTRACT

The object is to provide a miniature-sized tapered roller bearing that includes an inner race having an inner diameter of not more than 9 mm and that ensures high dynamic load rating.

The ratio of the average diameter DR_{AVE} of the tapered rollers 3 to the inner diameter DIᵢ of the inner race 1, i.e. DR_{AVE}/DIᵢ is set to 0.45 to 0.70 to ensure high dynamic load rating with a miniature-sized tapered roller bearing of which the inner race 1 has an inner diameter of not less than 9 mm.

### TECHNICAL FIELD

This invention relates to a miniature-sized tapered roller bearing.

### BACKGROUND ART

In speed reducers mounted on robotic arms and hands, angular ball bearings and tapered roller bearings, which can support radial and axial loads, are used as rolling bearings (as disclosed I Patent document 1). Miniature-sized rolling bearings of which the inner race has an inner diameter of 9 mm or less are often necessary in speed reducers mounted on small-sized robots for precision machining or for medical use. Conventional such miniature-sized rolling bearings are limited to ball bearings, and for the above-mentioned use, angular ball bearings have been used.

Patent document 1: JP2005-240997A

### DISCLOSURE OF THE INVENTION

### Object of the Invention

For today's robots for precision machining and for medical use, ones that are smaller in size and can generate higher outputs are required. If conventional miniature-sized angular ball bearings are used as rolling bearings in e.g. speed reducers mounted on such robots, they are often insufficient in the load carrying capacity. It is generally known that tapered roller bearings have a higher load carrying capacity than angular ball bearings. Thus, a miniature-sized tapered roller bearing is desired which shows a sufficiently high load carrying capacity, i.e. ensures high dynamic load rating for the above-mentioned use.

An object of this invention is to provide a miniature-sized tapered roller bearing that includes an inner race having an inner diameter of not more than 9 mm and that ensures high dynamic load rating.

In order to achieve this object, the present invention provides a tapered roller bearing comprising an inner race and an outer race having raceways, respectively, and a plurality of tapered rollers disposed between the raceways and retained by a retainer, characterized in that the inner race has an inner diameter DIᵢ of not more than 9 mm and that the ratio DR_{AVE}/DIᵢ, which is the ratio of the average diameter DR_{AVE} of the tapered rollers to the inner diameter DIᵢ of the inner race, is 0.45-0.70. The average diameter DR_{AVE} of the tapered rollers is half the sum of the maximum and minimum diameters of the tapered rollers at both ends of the effective length of the tapered rollers, not including the chamfered portions at both ends.

It is known, as shown in FIGS. 3(a) and 3(b), that the dynamic load rating Pc of ordinary roller bearings is proportional to DR^{29/27} and N^{3/4}, where DR is the diameter of the rollers and N is the number of rollers used (JIS B 1518). Since the rollers have to be arranged along the circumference of the pitch circle, there is the following relation (1) between the diameter DR and the number N of the rollers:

(DR+C)·N=π(DI_{O}+DR) (1)

where C is a circumferential gap between any adjacent rollers, and DI_{O} is the outer diameter of the raceway of the inner race.

Thus, based on the relationship between the dynamic load rating Pc and the diameter DR and the number N of rollers, as shown in FIGS. 3(a) and 3(b), and the relationship between the diameter DR and the number N of rollers, as expressed by the equation (1), the dynamic load rating Pc of a roller bearing is given by the following equation (2):

Pc=a{π(DI_{O}+DR)/(DR+C)}^{3/4}·DR^{29/27} (2)

where a is a proportionality factor.

From the equation (2), the inventors of the present invention considered that the dynamic load rating PC of a tapered roller bearing can be increased more markedly by increasing the diameter DR than by increasing the number N of tapered rollers, and calculated, as shown in FIG. 2, which describes the below examples, the dynamic load rating Pc of a miniature-sized tapered roller bearing of which the inner race has an inner diameter DIᵢ of not more than 9 mm, based on the equation (2) when the average diameter DR_{AVE} of the tapered rollers of the tapered roller bearing is substituted for the roller diameter DR in equation (2) and the average outer diameter DI_{OAVE} of the raceway of the inner race of the tapered roller bearing is substituted for the outer diameter DI_{O} of the raceway of the inner race in equation (2), and when the ratio DR_{AVE}/DIᵢ is changed. From the calculation results, it has been confirmed that the dynamic load rating increases more markedly when the ratio DR_{AVE}/D_{Ii} is not less than 0.45 than when the ratio DR_{AVE}/DIᵢ is 0.02 to 0.44.

Based on the above consideration and confirmation of the calculation results, the present invention provides a miniature-sized tapered roller bearing wherein the ratio DR_{AVE}/DIᵢ, which is the ratio of the average diameter BR_{AVE} of the tapered rollers to the inner diameter DIᵢ of the inner race, is 0.45 to 0.70 to ensure high dynamic load rating Pc. The upper limit of the ratio DR_{AVE}/DIᵢ is set to 0.70, because if this ratio is higher than 0.70, the number N of the tapered rollers is too small to keep a circumferential balance of the bearing.

### ADVANTAGES OF THE INVENTION

The present invention provides a miniature-sized tapered roller bearing of which the inner race has an inner diameter DIᵢ of not more than 9 mm, wherein the ratio DR_{AVE}/DIᵢ, which is the ratio of the average diameter DR_{AVE} of the tapered rollers to the inner diameter DIᵢ of the inner race, is 0.45 to 0.70. It is thus possible to ensure high dynamic load rating Pc.

### BRIEF DESCRIPTION OF THE DRAWINGS

FIG. 1 is a vertical sectional view of a tapered roller bearing embodying the invention.

FIG. 2 is a graph showing the relationship between the ratio of the average diameter of the tapered rollers to the inner diameter of the inner race and the dynamic load rating.

FIGS. 3a and 3b are graphs showing the relationships between the dynamic load rating of an ordinary roller bearing and the diameter and number of the rollers thereof, respectively.

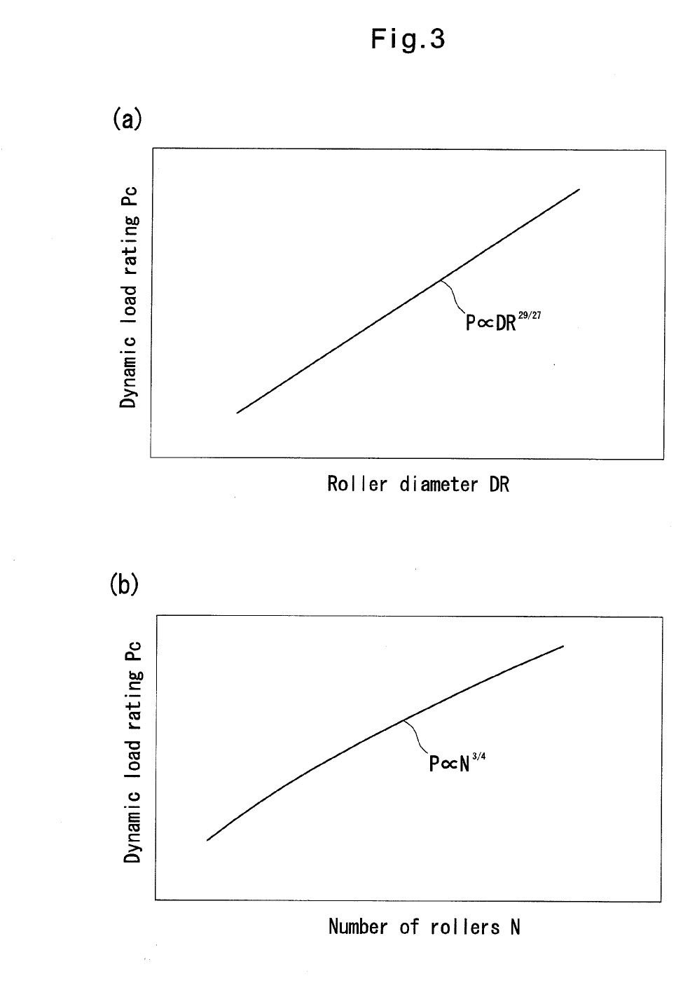

1. Inner race
2. Outer race
1a, 2a. Raceway
3. Tapered roller
4. Retainer

### BEST MODE FOR EMBODYING THE INVENTION

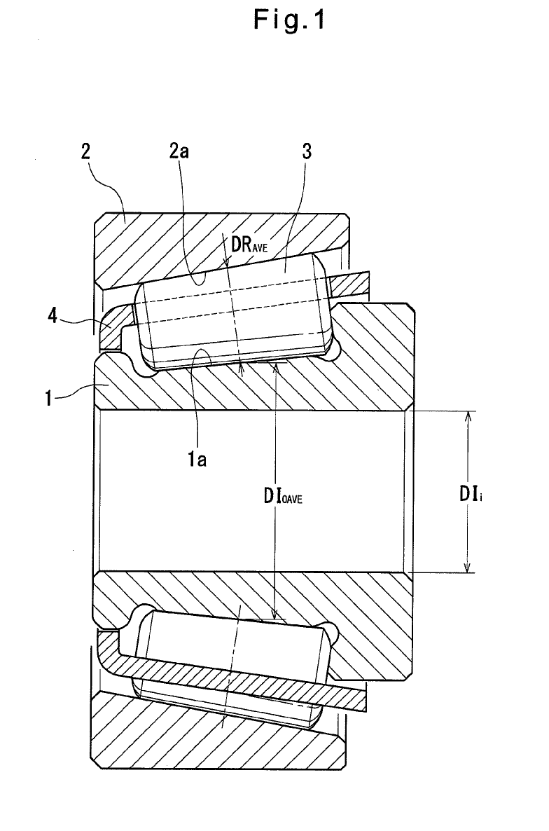

Now the embodiment of the present invention is described with reference to the drawings. As shown in FIG. 1, this tapered roller bearing is a miniature-sized bearing including an inner race 1 having an inner diameter DL of 5 mm and having a raceway 1a, an outer race 2 having a raceway 2a, and a plurality of tapered rollers 3 disposed between the raceways 1a and 2a and retained by a retainer 4. The ratio of the average diameter DR_{AVE} of the tapered rollers 3 to the inner diameter DIᵢ of the inner race 1, i.e. the ratio DR_{AVE}/DIi is 0.58.

### EXAMPLES

Based on the equation (3), to which the equation (2) is applied, the dynamic load rating Pc was calculated for each of miniature-sized tapered roller bearings having an inner race 1 having an inner diameter DL of 5 mm and each having a ratio DR_{AVE}/DIᵢ, which is the ratio of the average diameter DR_{AVE} of the tapered rollers to the inner diameter DIᵢ of the inner race, of 0.45 to 0.70 (Example of the invention), and of not more than 0.44 (Comparative Example).

Pc=a₁{π(DI_{OAVE}+DR_{AVE})/(DR_{AVE}+C)}^{3/4}·DR_{AVE}^{29/27} (3)

where a₁ is a proportionality factor.

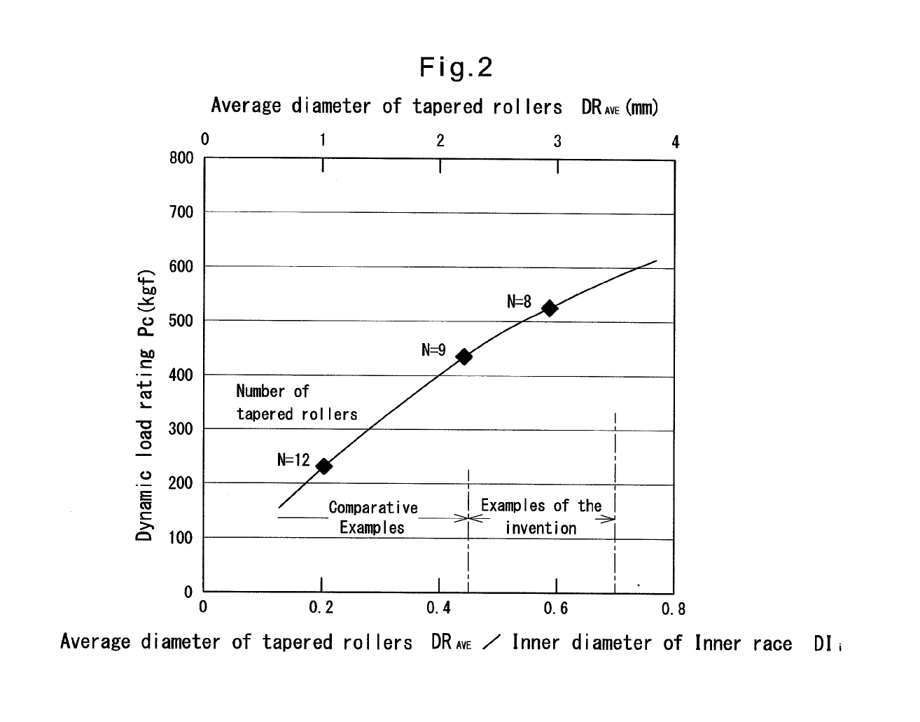

The graph of FIG. 2 shows the results of calculation for the tapered roller bearings having an inner ring 1 with an inner diameter DIᵢ of 5 mm, wherein the average diameter DI_{OAVE} of the raceway 1a, which corresponds to DIᵢ, is 7.87 mm, and the circumferential gap C between tapered rollers 3 is 1.3 mm. The horizontal axis of the graph also indicates the average diameter DR_{AVE} of the corresponding tapered rollers 3. At each plot of the graph, the number of tapered rollers 3 of each bearing, which is determined by the equation (1), is shown.

As is apparent from these calculation results, the larger the ratio DR_{AVE}/DIᵢ, the smaller the number of tapered rollers 3, but the dynamic load rating Pc of the tapered roller bearing increases markedly. In particular, in Examples of the invention, in which the ratio DR_{AVE}/DIᵢ is 0.45 to 0.70, the dynamic load ratings Pc are markedly larger than those of Comparative Examples, in which the ratio DR_{AVE}/DIᵢ is not more than 0.44. It is thus apparent that by setting the ratio DR_{AVE}/DIᵢ to 0.45 to 0.70, the miniature-sized tapered roller bearing exhibits high dynamic load rating Pc.

### INDUSTRIAL APPLICABILITY

Because the tapered roller bearing according to the present invention is a miniature-sized one having high dynamic load rating, it can be advantageously used in a speed reducer of a compact and high-output robot, to support a driving shaft of an electric tool such as a compact and high-output electric drill electric screwdriver, and to support a spindle of a small machine tool.

What is claimed is:

1. A tapered roller bearing comprising an inner race and an outer race having raceways, respectively, and a plurality of tapered rollers disposed between the raceways and retained by a retainer, characterized in that said inner race has an inner diameter DIᵢ of not more than 9 mm and that the ratio DR_{AVE}/DIᵢ, which is the ratio of the average diameter DR_{AVE} of the tapered rollers to the inner diameter DIᵢ of the inner race.

2. The tapered roller bearing of claim 1 which is used in a speed reducer of a robot.

3. The tapered roller bearing of claim 1 which is used to support a driving shaft of an electric tool such as an electric drill or an electric screwdriver.

4. The tapered roller bearing of claim 1 which is used to support a spindle of a small machine tool.
